(19) United States
(12) Patent Application Publication
(10) Pub. No.: US 2015/0134480 A1
(43) Pub. Date: May 14, 2015

(54) SYSTEMS AND METHODS TO PRESENT DIGITAL CONTENT LISTINGS

(71) Applicant: Steven John Marks, Kleinmachnow (DE)

(72) Inventor: Steven John Marks, Kleinmachnow (DE)

(21) Appl. No.: 14/467,976

(22) Filed: Aug. 25, 2014

Related U.S. Application Data
(60) Provisional application No. 61/904,288, filed on Nov. 14, 2013.

(51) Int. Cl. G06Q 30/06

(52) U.S. Cl. CPC G06Q 30/0603; G06Q 30/0609; G06Q 30/0623
USPC 705/26.35; 705/26.61

(57) ABSTRACT

Systems and methods to present digital content listings are described herein. A selection of digital content listings from a catalog of digital content listings is received. The catalog of digital content listings describes digital content available for download. The selection may be received from a mobile device of a merchant operating a brick-and-mortar store. Digital content listings are accessed from the catalog of digital content listings based on the received selection of digital content listings. A consumer is determined to be located within a pre-defined distance from a brick-and-mortar store. The accessed digital content listings are presented to the mobile device of the consumer.

### RELATED APPLICATION

This application claims the priority benefit of U.S. Provisional Patent Application No. 61/904,288 filed Nov. 14, 2013, which is incorporated herein by reference in its entirety.

### TECHNICAL FIELD

The subject matter disclosed herein generally relates to the processing of data. Specifically, the present disclosure addresses systems and methods to facilitate selection and presentation of digital content listings from a catalog.

### BACKGROUND

A user may browse a web page for listings of digital content. The listings may include an option that allows the user to purchase the digital content and download the digital content onto a client device with internet capabilities.

### BRIEF DESCRIPTION OF THE DRAWINGS

Some embodiments are illustrated by way of example and not limitation in the figures of the accompanying drawings.

FIG. 1 is a network diagram illustrating a network environment suitable for presenting digital content listings, according to some example embodiments.

FIG. 2 is a block diagram illustrating components of a server machine suitable for presenting digital content listings, according to some example embodiments.

FIG. 3 is an example user interface that illustrates a catalog of digital content listings being displayed on a mobile device, according to some example embodiments.

FIG. 4-5 are example user interfaces that illustrate a selection of digital content listings displayed on a mobile device, according to some example embodiments.

FIG. 6 is an example user interface that illustrates digital content listings that are available for sale and displayed on a mobile device, according to some example embodiments.

FIG. 7-9 are flowcharts illustrating operations of a server machine in performing a method of presenting digital content listings, according to some example embodiments.

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems are directed to selection and presentation of digital content listings from a catalog. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

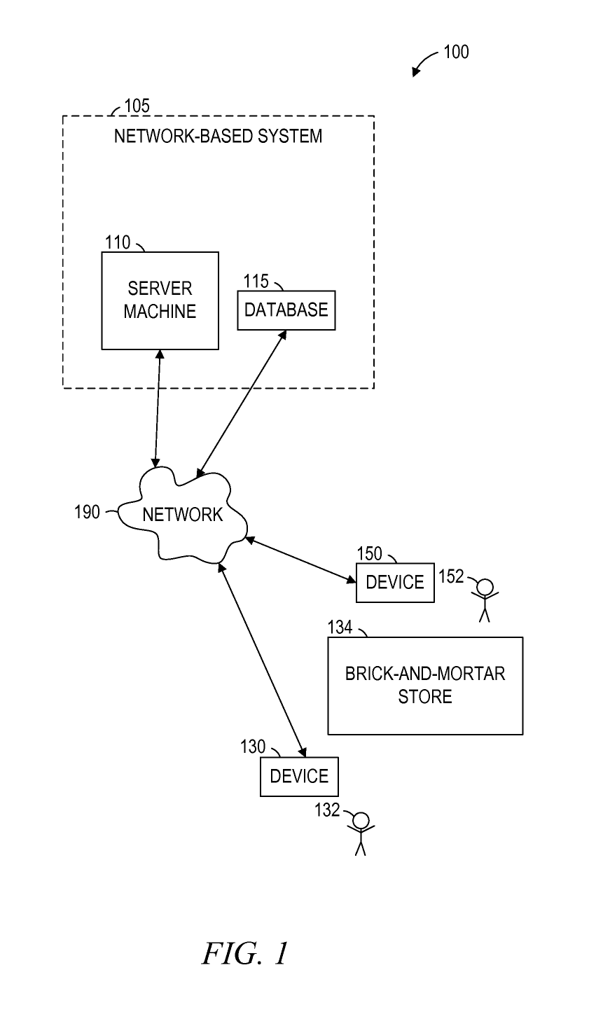

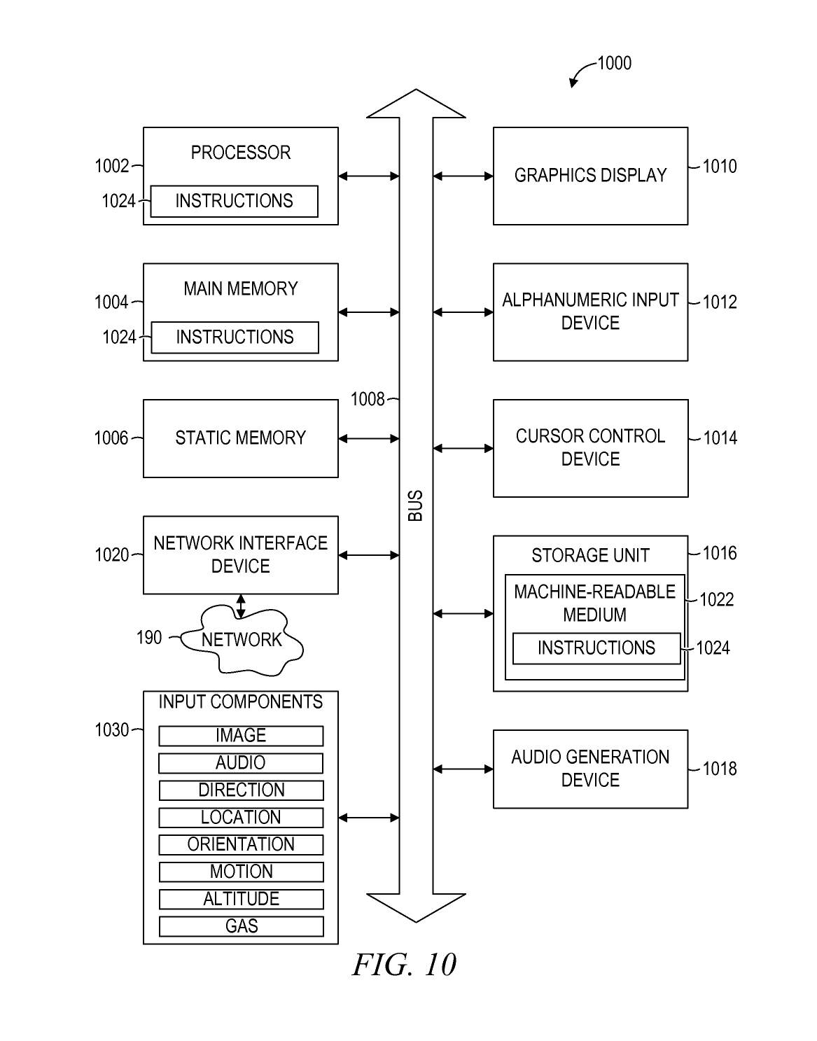

FIG. 1 is a network diagram illustrating a network environment 100 suitable for presenting digital content listings, according to some example embodiments. The network environment 100 includes a server machine 110, a database 115, and devices 130 and 150, all communicatively coupled to each other via a network 190. The server machine 110 may form all or part of a network-based system 105 (e.g., a cloud-based server system configured to provide one or more services to the device 130). The server machine 110 and the device 130 may each be implemented in a computer system, in whole or in part, as described below with respect to FIG. 10.

Also shown in FIG. 1 are users 132 and 152. The user 132 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150 and may be a user of the device 150. For example, the device 150 may be a desktop computer, a vehicle computer, a tablet computer, a navigational device, a portable media device, a smartphone, or a wearable device (e.g., a smart watch or smart glasses) belonging to the user 152. Also shown in FIG. 1 is a brick-and-mortar store 134.

In some instances, the user 152 is a merchant that is operating a brick-and-mortar store 134. The user 152 may send a selection of digital content listings from a catalog of digital content listings from the device 150 to the server machine 110. Upon receiving the selection of digital content listings from the device 150, the server machine 110 may access the selected digital content listings from the catalog of digital content listings. The catalog of digital content listings may be stored in the database 115. Moreover, the server machine 110 may send the accessed digital content listings to a device 130 of a user 132 that is determined to be within a pre-defined distance from the brick-and-mortar store 134. The user 132 can browse the digital content listings on the device 130 and choose to download or purchase the digital content presented in the digital content listings.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

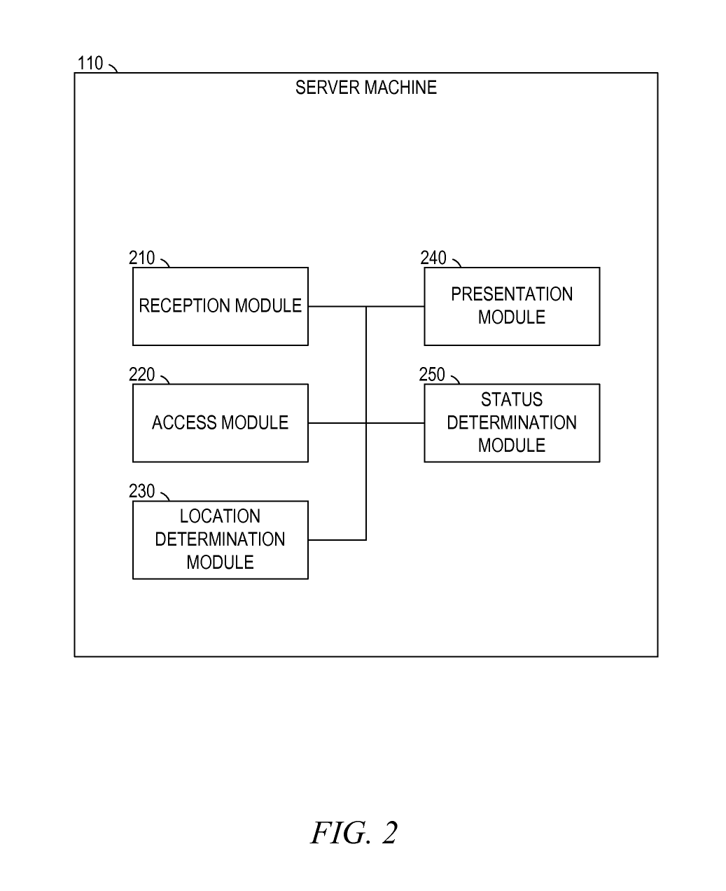

FIG. 2 is a block diagram illustrating components of the server machine 110, according to some example embodiments. The server machine 110 is shown as including a reception module 210, an access module 220, a location determination module 230, a presentation module 240, and a status determination module 250 all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the reception module 210 is configured to receive a selection of digital content listings from an online catalog of digital content listings. The online catalog of digital content listings includes digital content listings that describe digital content available for download via a mobile device of a consumer. For instance, a digital content listing may include a price, a description, and an image of the digital content. The online catalog of digital listings may hosted by the server machine 110. Moreover, the digital content described by the online catalog may be stored in the database 115. Digital content may include digital books, digital music, digital animation, digital games, and the like. In various example embodiments, the selection of digital content is received from a mobile device of a merchant operating a brick-and-mortar store. The selection of digital content may also be received from a mobile device of other merchants that may not be operating a brick-and-mortar store. The entire online catalog of digital content listings may be displayed on the mobile device of the merchant. As further explained below, the entire catalog of digital content listings may be provided by the presentation module 240. Moreover, the merchant may use the mobile device to indicate the selection of digital content listings, which is then sent from the mobile device to the reception module 210. In some instances, the selection of digital content listings includes identifying a plurality of digital content listings according to a category, an author, a publisher, an album, or a genre. For example, the merchant may simultaneously select digital content listings that all belong in a certain category. As another example, the merchant may simultaneously select all the digital content listings that describe digital content distributed by a certain publisher.

As further explained below, the consumer may purchase digital content from the digital content listings selected by the merchant operating the brick-and-mortar store. In some instances, the consumer may download the digital content from the database 115 hosted by the server 110 onto the mobile device. In some instances, the consumer may interact with the digital content on the mobile device. In various example embodiments, the reception module 210 is further configured to receive a location of the brick-and-mortar store from the mobile device of the merchant operating the brick-and-mortar store. In various example embodiments, the reception module 210 is further configured to receive a request to download digital content described in a digital content listing among the digital content listings presented to the mobile device of the consumer, as further explained below.

In various example embodiments, the access module 220 is configured to access digital content listings from the online catalog of digital content listings based on the selection of digital content listings received at the reception module 210. The access module 220 may access the digital content listings that were selected by the merchant from the online catalog of digital content listings. In various example embodiments, the access module 220 is further configured to access digital content listings that correspond to a pre-defined status achieved by the merchant, as further explained below. Moreover, the digital content listings that correspond to the pre-defined status may be accessed from the online catalog of digital content listings by the access module 220. The digital content listings that correspond to the pre-defined status may correspond to a pre-defined section of the catalog. In some instances, the digital content listings that correspond to the pre-defined status include an entire section of the online catalog of digital content listings. For example all digital books published by a certain publisher may be included as part of the digital content listings that correspond to the pre-defined status. In some instances, the entire catalog of digital content listings may correspond to the pre-defined status. In various example embodiments, the access module 220 is further configured to update the accessed digital content listings with additional information. The new information may include a new price of a digital content listing among the accessed digital content listings, a new description of the digital content listing among the accessed digital content listings, a new image of the digital content listing among the accessed digital content listings, or any suitable combination thereof.

In various example embodiments, the location determination module 230 is configured to determine that the consumer is located within a pre-defined distance from the brick-and-mortar store. In various example embodiments, the location determination module 230 is further configured to send the location of the brick-and-mortar store to the mobile device of the consumer. For instance, the mobile device of the consumer may receive a notification regarding the brick-and-mortar store. In various example embodiments, the location determination module 230 is further configured to receive an indication from the mobile device of the consumer that the mobile device is within the pre-defined distance from the location of the brick-and-mortar store. For example, the consumer may perform a check-in using the mobile device of the consumer, which sends a message to the location determination module 230 that the consumer has arrived at the brick-and-mortar store. In some instances, the location determination module 230 may receive a location of the mobile device of the consumer. The location determination module 230 may compare the location of the mobile device of the consumer with the location of the brick-and-mortar store in order to determine that the consumer is located within the pre-defined distance from the brick-and-mortar store. In some instance, the location determination module 230 may detect that the consumer has crossed a geofence that surrounds the brick-and-mortar store. Moreover, the boundaries of the geofence may be located at the pre-defined distance from the brick-and-mortar store.

In various example embodiments, the presentation module 240 is configured to present the accessed digital content listings to the mobile device of the consumer. In some instances, the presenting the accessed digital content listings is performed automatically by the presentation module 240 and without interaction with the mobile device of the merchant. The consumer may view the digital content listings on the mobile device and decide whether or not to purchase any of the digital content described by the digital content listings. In various example embodiments, the presentation module 240 is further configured to present the additional information to the mobile device of the consumer. In various example embodiments, the presentation module 240 is further configured to present the digital content to the mobile device of the consumer in response to receipt of the request received at the reception module 210. For instance, the presentation module 240 may download the digital content from the database 115 hosted by the server machine 110 to the mobile device of the consumer. In various example embodiments, the presentation module 240 is further configured to publish the accessed digital content listings to a web page corresponding to the merchant of the brick-and-mortar store. A consumer may then browse the web page to view the digital content listings and decide whether or not to purchase any of the digital content described by the digital content listings on the web page. In various example embodiments, the presentation module 240 is further configured to present the online catalog of digital content listings to the mobile device of the merchant prior to the reception module 210 receiving the selection of digital content listings. In various example embodiments, the presentation module 240 is further configured to present the accessed digital content listings that correspond to the pre-defined status to the mobile device of the consumer. The pre-defined status is further explained below.

In various example embodiments, the status determination module 250 is configured to: access a seller profile of the merchant operating the brick-and-mortar store; and determine that the merchant has achieved the pre-defined status based on the seller profile of the merchant. The seller profile of the merchant may indicate seller behavior of the merchant in previous transactions for digital content. For instance, the pre-defined status may require a merchant to sell at least a threshold number of digital content from the catalog of digital content listings. The seller profile may also indicate whether the merchant is a registered seller. For instance, the pre-defined status may require a merchant to register or create an account that is managed by the server machine 110 and stored in the database 115.

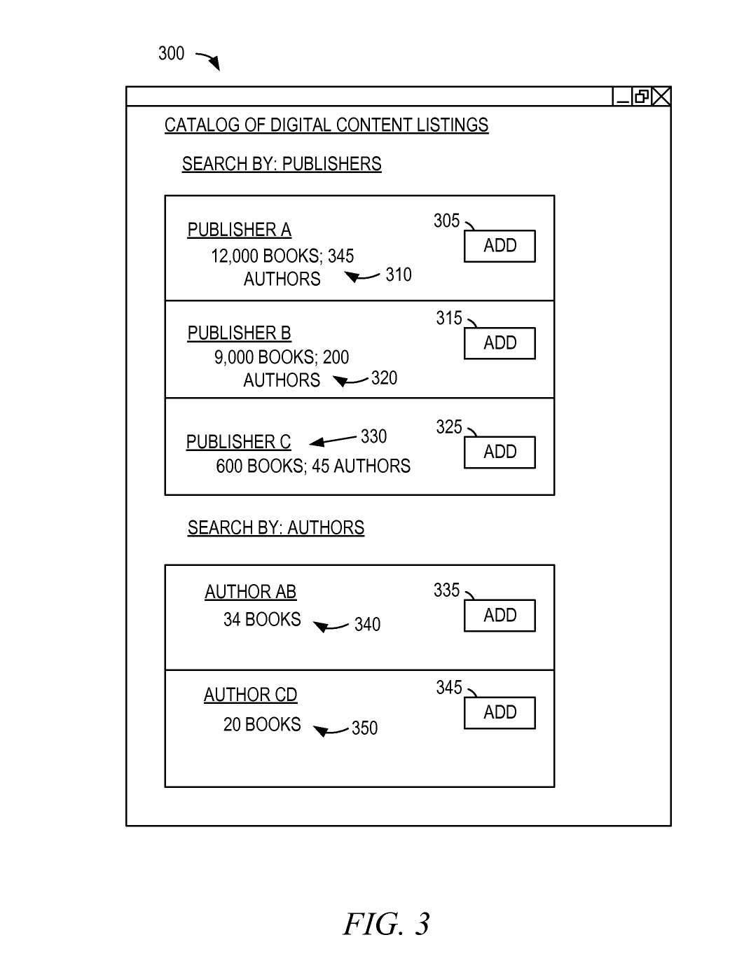

FIG. 3 is an example user interface 300 that illustrates a catalog of digital content listings being displayed on a mobile device, according to some example embodiments. The user interface 300 may be displayed on a mobile device of a merchant. The merchant may use the controls displayed in the user interface 300 to indicate a selection of digital content listings from the catalog of digital content listings. Moreover, each of the digital content listings may be grouped together as a plurality of digital content listings along with a description of the digital content listings. The user interface 300 may include a first portion that shows a first plurality of digital content listings 310, a second plurality of digital content listings 320, and a third plurality of digital content listings 330. The first portion of the user interface 300 may show digital content listings grouped according to publisher. The user interface 300 may further include a first control 305 operable to select the first plurality of digital content listings 310, a second control 315 operable to select the second plurality of digital content listings 320, and a third control 325 operable to select the third plurality of digital content listings 330. The user interface 300 may also include a second portion that shows a fourth plurality of digital content listings 340 and a fifth plurality of digital content listings 350. The second portion of the user interface may show digital content listings grouped according to author. The user interface 300 may also include a fourth control 335 operable to select the fourth plurality of digital content listings 340 and a fifth control 345 operable to select the fifth plurality of digital content listings 350.

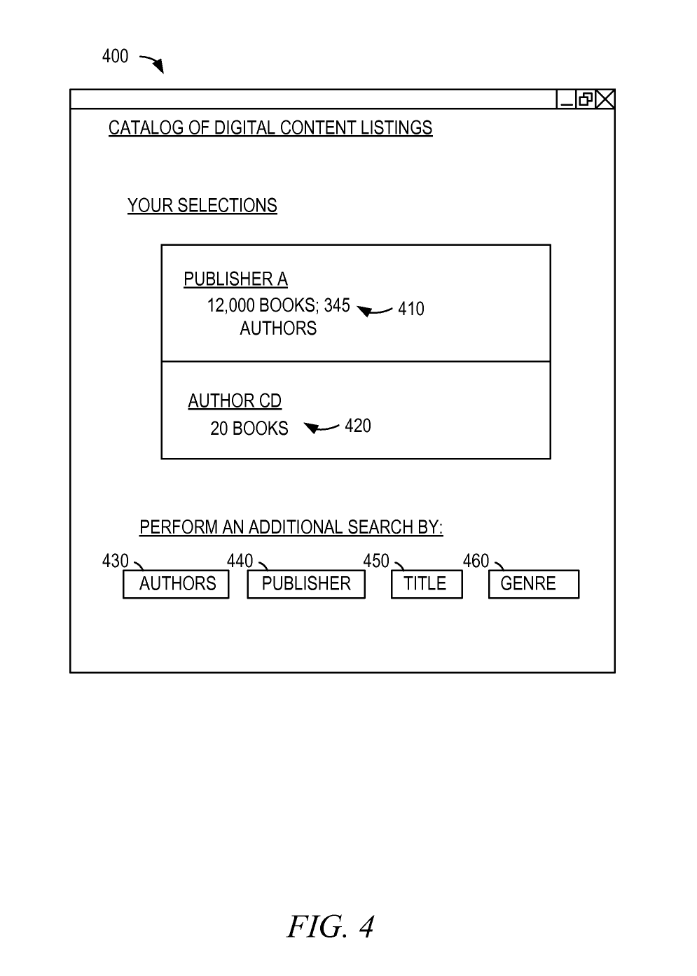

FIG. 4 is an example user interface 400 that illustrates a selection of digital content listings displayed on a mobile device, according to some example embodiments. The user interface 400 may be displayed on a mobile device of a merchant. The user interface 400 may include a portion that displays selections made by the merchant. For instance, a first selection 410 and a second selection 420 are displayed in the user interface 400. Moreover, the first selection 410 may correspond to the control 305 of FIG. 3 and the second selection 420 may correspond to the control 345 of FIG. 3. The user interface 400 further includes controls 430, 440, 450, and 460 each being operable to perform an additional search from the online catalog of digital content listings. Control 430 may be operable to perform an additional search for digital content listings from a certain author. Control 440 may operable to perform an additional search for digital content listings from a certain publisher. Control 450 may be operable to perform an additional search for digital content listings of a certain title. Control 460 may be operable to perform an additional search for digital content listings of a certain genre.

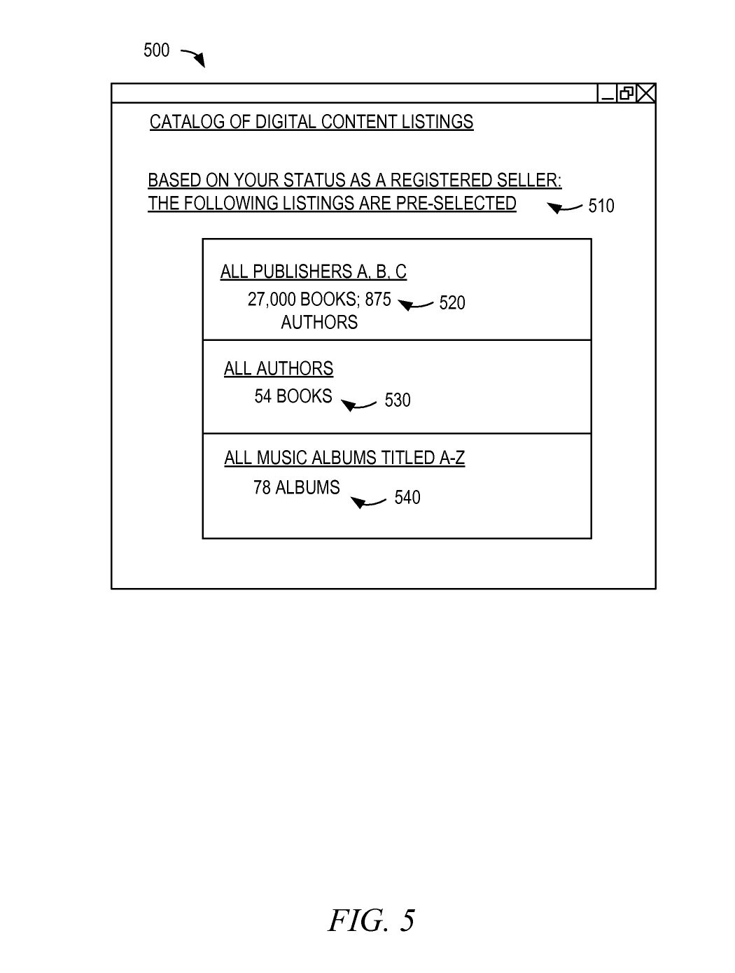

FIG. 5 is an example user interface 500 that illustrates a selection of digital content listings displayed on a mobile device, according to some example embodiments. The user interface 500 may be displayed on a mobile device of a merchant. The user interface 500 may include a first selection 520, a second selection 530, and a third selection 540. Each of the selections may correspond to a pre-defined status achieved by a merchant. Moreover, the access module 220 may access each of the first selection 520, the second selection 530, and the third selection 540 in order to make them available for sale. The example user interface 500 also includes a message 510 to indicate that the merchant has achieved a pre-defined status.

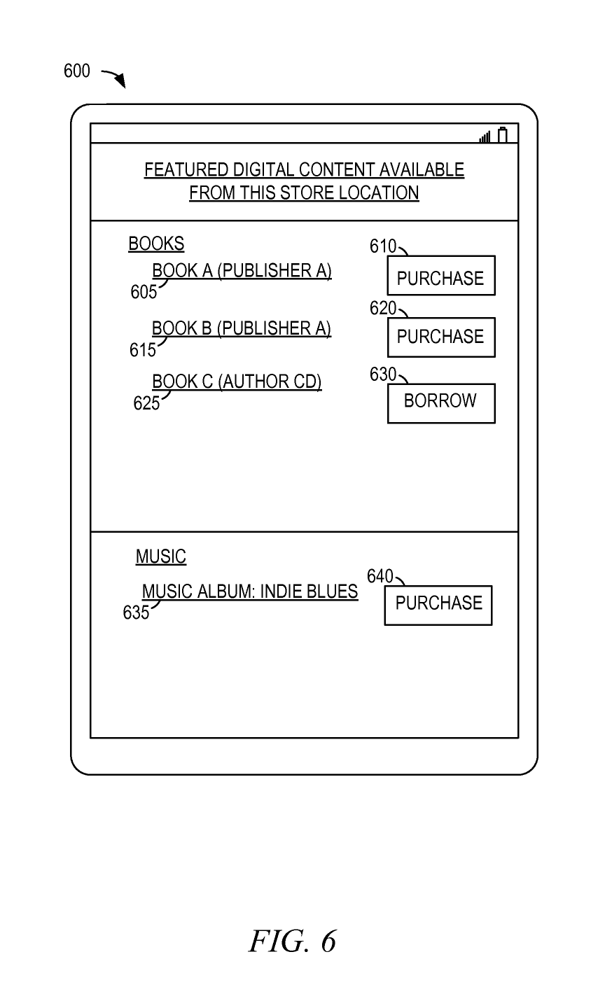

FIG. 6 is an example user interface 600 that illustrates digital content listings that are available for sale and displayed on a mobile device, according to some example embodiments. The user interface 600 may be displayed on a mobile device of a consumer. The user interface 600 may include a first portion that displays a first listing 605, a second listing 615, and a third listing 625. The first portion may display digital content listings for a certain type of digital content, such as books. The user interface 600 may further include a second portion that displays a fourth listing 635. The second portion may display digital content listings for a certain type of digital content, such as music. The user interface 600 may also include a first control 610 operable to purchase digital content of the first listing 605, a second control 620 operable to purchase digital content of the second listing 615, a third control 630 operable to borrow digital content of the third listing 625, and a fourth control 640 operable to purchase digital content of the fourth listing 635. Moreover, digital content may be downloaded to the mobile device of the consumer upon operation of any of controls 610, 620, 630, and 640.

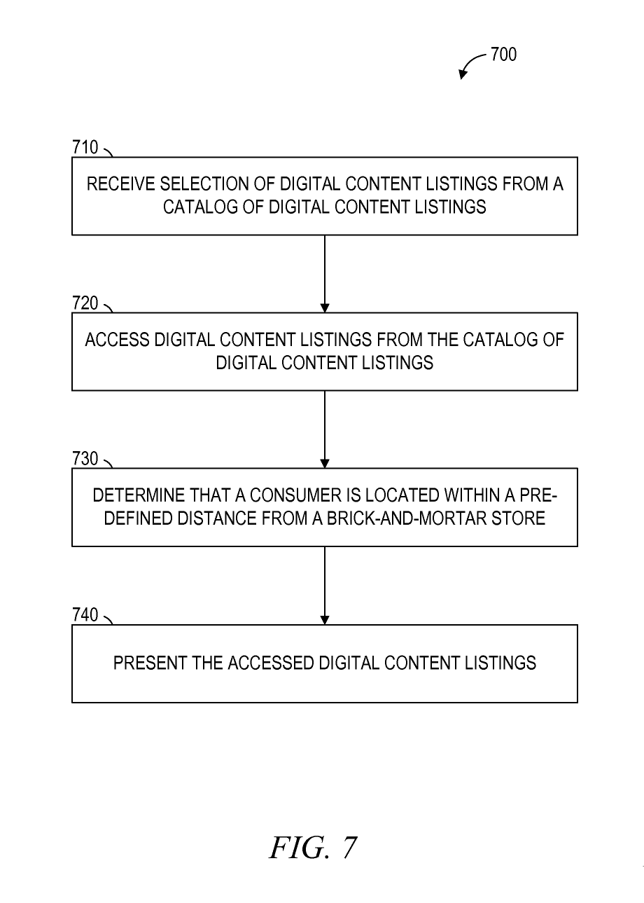

FIG. 7-9 are flowcharts illustrating operations of a server machine in performing a method 700 of presenting digital content listings, according to some example embodiments. Operations in the method 700 may be performed by the server machine 110, using modules described above with respect to FIG. 2. As shown in FIG. 7, the method 700 includes operations 710, 720, 730, and 740.

At operation 710, the reception module 210 receives a selection of digital content listings from an online catalog of digital content listings. The online catalog of digital content listings includes digital content listings that describe digital content available for download via a mobile device of a consumer. The online catalog of digital listings may hosted by the server machine 115. Moreover, the digital content described by the online catalog may be stored in the database 115. The selection of digital content is received from a mobile device of a merchant operating a brick-and-mortar store.

At operation 720, the access module 220 accesses digital content listings from the catalog of digital content listings based on the selection of digital content listings received by the reception module 210 at operation 710.

At operation 730, the location determination module 230 determines that the consumer is located within a pre-defined distance from the brick-and-mortar store.

At operation 740, the presentation module 240 presents the accessed digital content listings to the mobile device of the consumer.

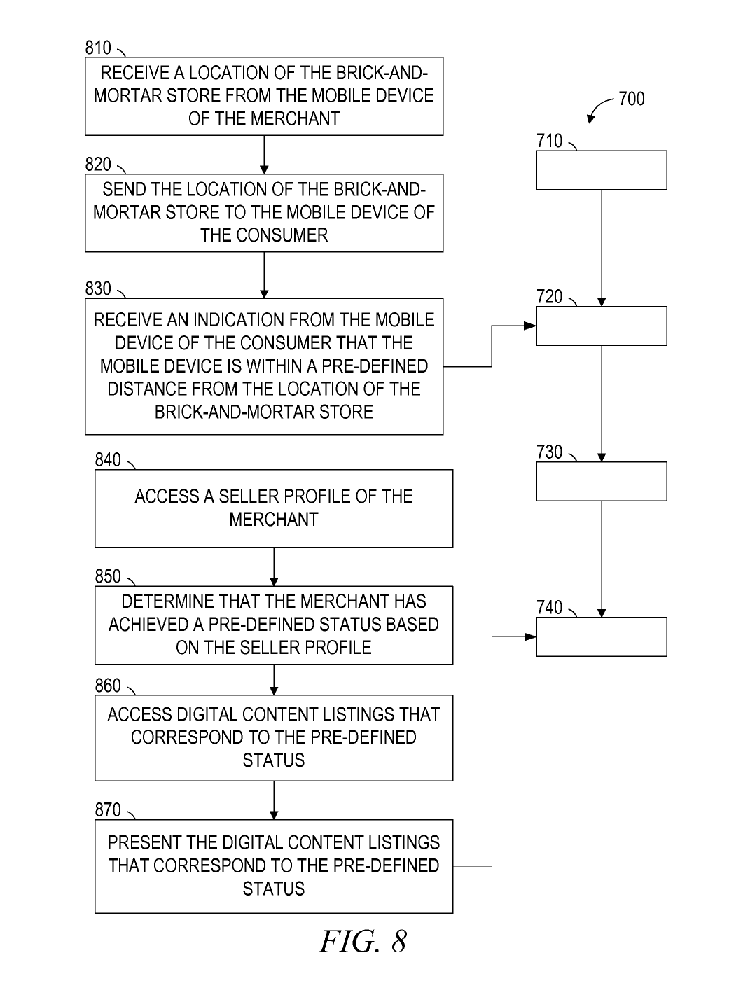

As shown in FIG. 8, the method 700 may include one or more of operations 810, 820, 830, 840, 850, 860, and 870. One or more of operations 810-830 may be performed as part (e.g., a precursor task, a subroutine, or a portion) of operation 720. Moreover, one or more of operations 840-870 may be performed as part of (e.g., a precursor task, a subroutine, or a portion) of operation 740.

At operation 810, the reception module 210 receives the location of the brick-and-mortar store from the mobile device of the merchant operating the brick-and-mortar store.

At operation 820, the location determination module 230 sends the location of the brick-and-mortar store to the mobile device of the consumer.

At operation 830, the location determination module 230 receives an indication from the mobile device of the consumer that the mobile device is within a pre-defined distance from the location of the brick-and-mortar store. The indication received from the mobile device of the consumer may be used by the location determination module 230 to determine that the consumer is located within the pre-defined distance from the brick-and-mortar store as performed at operation 730 of FIG. 7.

At operation 840, the status determination module 250 accesses a seller profile of the merchant. The seller profile of the merchant may indicate seller behavior of the merchant in previous transactions for digital content. The seller profile may also indicate whether the merchant is a registered seller.

At operation 850, the status determination module 250 determines that the merchant has achieved a pre-defined status based on the accessed seller profile. For instance, the pre-defined status may require a merchant to sell at least a threshold number of digital content from the catalog of digital content listings. As another example, the pre-defined status may require a merchant to register or create an account.

At operation 860, the access module 220 accesses the digital content listings that correspond to the pre-defined status achieved by the merchant. In some instances, the digital content listings that correspond to the pre-defined status include an entire section of the online catalog of digital content listings. For example all digital books published by a certain publisher may be included as part of the digital content listings that correspond to the pre-defined status. In some instances, the entire catalog of digital content listings may correspond to the pre-defined status.

At operation 870, the presentation module 240 presents the digital content listings that correspond to the pre-defined status to the mobile device of the consumer. The operation 870 may be performed as part of the operation 720 of FIG. 7. The digital content listings that correspond to the pre-defined status may correspond to a pre-defined section of the catalog. The digital content listings that correspond to the pre-defined status may correspond to a pre-defined section of the catalog. In some instances, the digital content listings that correspond to the pre-defined status include an entire section of the online catalog of digital content listings. For example all digital books published by a certain publisher may be included as part of the digital content listings that correspond to the pre-defined status. In some instances, the entire catalog of digital content listings may correspond to the pre-defined status.

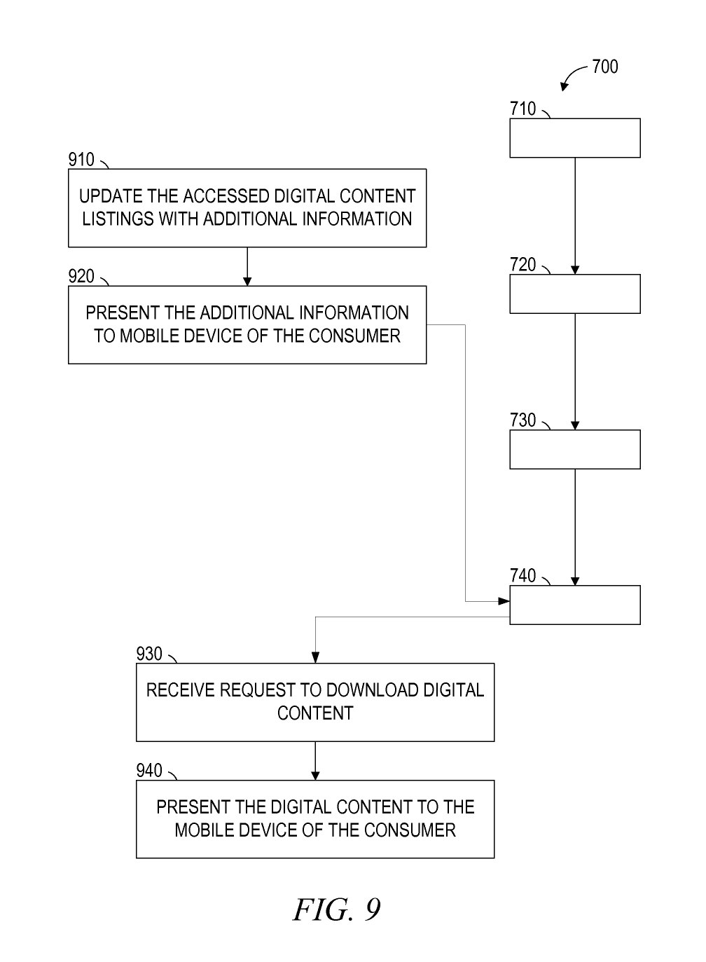

As shown in FIG. 9, the method 700 may include one or more of operations 910, 920, 930, and 940. One or more of operations 910 and 920 may be performed as part (e.g., a precursor task, a subroutine, or a portion) of operation 740. Moreover, one or more of operations 930 and 940 may be performed after operation 740.

At operation 910, the access module 220 updates the selected digital content listings with additional information. The new information may include a new price of a digital content listing among the accessed digital content listings, a new description of a digital content listing among the accessed digital content listings, a new image of a digital content listing among the accessed digital content listings, or any suitable combination thereof. In other words, the additional information may be used to update a description from the digital content listings. The additional information may also add new descriptions to the digital content listings.

At operation 920, the presentation module 240 presents the additional information to the mobile device of the consumer.

At operation 930, the reception module 210 receives a request from the mobile device of the consumer to download digital content described in the digital content listings presented to the mobile device of the consumer.

At operation 940, the presentation module 240 presents the digital content to the mobile device of the consumer.

According to various example embodiments, one or more of the methodologies described herein may facilitate presenting digital content listings. When these effects are considered in aggregate, one or more of the methodologies described herein may obviate a need for certain efforts or resources that otherwise would be involved in presenting digital content listings. Efforts expended by a merchant in presenting digital content listings may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 10 is a block diagram illustrating components of a machine 1000, according to some example embodiments, able to read instructions 1024 from a machine-readable medium 1022 (e.g., a non-transitory machine-readable medium, a machine-readable storage medium, a computer-readable storage medium, or any suitable combination thereof) and perform any one or more of the methodologies discussed herein, in whole or in part. Specifically, FIG. 10 shows the machine 1000 in the example form of a computer system (e.g., a computer) within which the instructions 1024 (e.g., software, a program, an application, an applet, an app, or other executable code) for causing the machine 1000 to perform any one or more of the methodologies discussed herein may be executed, in whole or in part.

In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include any collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The processor 1002 may contain microcircuits that are configurable, temporarily or permanently, by some or all of the instructions 1024 such that the processor 1002 is configurable to perform any one or more of the methodologies described herein, in whole or in part. For example, a set of one or more microcircuits of the processor 1002 may be configurable to execute one or more modules (e.g., software modules) described herein.

The machine 1000 may further include a graphics display 1010 (e.g., a plasma display panel (PDP), a light emitting diode (LED) display, a liquid crystal display (LCD), a projector, a cathode ray tube (CRT), or any other display capable of displaying graphics or video). The machine 1000 may also include an alphanumeric input device 1012 (e.g., a keyboard or keypad), a cursor control device 1014 (e.g., a mouse, a touchpad, a trackball, a joystick, a motion sensor, an eye tracking device, or other pointing instrument), a storage unit 1016, an audio generation device 1018 (e.g., a sound card, an amplifier, a speaker, a headphone jack, or any suitable combination thereof), and a network interface device 1020.

The storage unit 1016 includes the machine-readable medium 1022 (e.g., a tangible and non-transitory machine-readable storage medium) on which are stored the instructions 1024 embodying any one or more of the methodologies or functions described herein. The instructions 1024 may also reside, completely or at least partially, within the main memory 1004, within the processor 1002 (e.g., within the processor's cache memory), or both, before or during execution thereof by the machine 1000. Accordingly, the main memory 1004 and the processor 1002 may be considered machine-readable media (e.g., tangible and non-transitory machine-readable media). The instructions 1024 may be transmitted or received over the network 190 via the network interface device 1020. For example, the network interface device 1020 may communicate the instructions 1024 using any one or more transfer protocols (e.g., hypertext transfer protocol (HTTP)).

In some example embodiments, the machine 1000 may be a portable computing device, such as a smart phone or tablet computer, and have one or more additional input components 1030 (e.g., sensors or gauges). Examples of such input components 1030 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1024 for execution by the machine 1000, such that the instructions 1024, when executed by one or more processors of the machine 1000 (e.g., processor 1002), cause the machine 1000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving, using one or more processors, a selection of digital content listings from a catalog of digital content listings, the catalog of digital content listings describing digital content available for download via a mobile device of a consumer, the selection being received from a mobile device of a merchant operating a brick-and-mortar store;
accessing digital content listings from the catalog of digital content listings based on the received selection of digital content listings;
determining that the consumer is located within a pre-defined distance from the brick-and-mortar store via the mobile device of the consumer; and
presenting the accessed digital content listings to the mobile device of the consumer.

2. The method of claim 1, further comprising:
accessing a seller profile of the merchant operating the brick-and-mortar store;
determining that the merchant has achieved a pre-defined status based on the seller profile of the merchant; and
accessing digital content listings that correspond to the pre-defined status achieved by the merchant, wherein the
presenting the accessed digital content listings includes presenting the accessed digital content listings that correspond to the pre-defined status to the mobile device of the consumer.

3. The method of claim 1, further comprising:
receiving a location of the brick-and-mortar store from the mobile device of the merchant.

4. The method of claim 1, wherein the determining that the consumer is located within the pre-defined distance from the brick-and-mortar store includes:
sending the location of the brick-and-mortar store to the mobile device of the consumer; and
receiving an indication from the mobile device of the consumer that the mobile device is within the pre-defined distance from the location of the brick-and-mortar store.

5. The method of claim 1, wherein the presenting the accessed digital content listings to the mobile device of the consumer is performed automatically without interaction with the mobile device of the merchant operating the brick-and-mortar store.

6. The method of claim 1, wherein the selection of digital content listings includes identifying a plurality of digital listings according to at least one of: a category, an author, a publisher, an album, or a genre.

7. The method of claim 1, further comprising:
updating the accessed digital content listings with additional information, and wherein the presenting the accessed digital content listings includes presenting the additional information to the mobile device of the consumer.

8. The method of claim 7, wherein the additional information includes at least one of: a new price of a digital content listing among the accessed digital content listings, a new description of the digital content listing among the accessed digital content listings, or a new image of the digital content listing among the accessed digital content listings.

9. The method of claim 1, further comprising:
receiving a request to download digital content described in a digital content listing among the digital content listings presented to the mobile device of the consumer, the request being received from the mobile device of the consumer; and
presenting the digital content to the mobile device of the consumer in response to receipt of the request.

10. The method of claim 1, further comprising:
publishing the accessed digital content listings to a web page corresponding to the merchant of the brick-and-mortar store.

11. The method of claim 1, further comprising:
prior to the receiving the selection of digital content listings from the mobile device of the merchant, presenting the catalog of digital content listings to the mobile device of the merchant.

12. A system comprising:
a reception module configured to receive a selection of digital content listings from a catalog of digital content listings, the catalog of digital content listings describing digital content available for download via a mobile device of a consumer, the selection being received from a mobile device of a merchant operating a brick-and-mortar store;
an access module configured to access digital content listings from the catalog of digital content listings based on the received selection of digital content listings;
a location determination module configured to determine that the consumer is located within a pre-defined distance from the brick-and-mortar store via the mobile device of the consumer; and
a presentation module configured to present the accessed digital content listings to the mobile device of the consumer.

13. The system of claim 12, further comprising:
a status determination module configured to:
access a seller profile of the merchant operating the brick-and-mortar store; and
determine that the merchant has achieved a pre-defined status based on the seller profile of the merchant;
wherein the access module is further configured to:
access digital content listings that correspond to the pre-defined status achieved by the merchant; and
wherein the presentation module is further configured to present the accessed digital content listings that correspond to the pre-defined status to the mobile device of the consumer.

14. The system of claim 12, wherein the reception module is further configured to receive a location of the brick-and-mortar store from the mobile device of the merchant.

15. The system of claim 12, wherein the location determination module is further configured to:
send the location of the brick-and-mortar store to the mobile device of the consumer; and
receive an indication from the mobile device of the consumer that the mobile device is within the pre-defined distance from the location of the brick-and-mortar store.

16. The system of claim 12, wherein the presentation module is further configured to present the accessed digital content listings to the mobile device of the consumer automatically and without interaction with the mobile device of the merchant operating the brick-and-mortar store.

17. The system of claim 12, wherein the selection of digital content listings includes identifying a plurality of digital listings according to at least one of: a category, an author, a publisher, an album, or a genre.

18. The system of claim 12, wherein the access module is further configured to update the accessed digital content listings with additional information, and wherein the presentation module is further configured to present the additional information to the mobile device of the consumer.

19. The system of claim 12, wherein the reception module is further configured to receive a request to download digital content described in a digital content listing among the digital content listings presented to the mobile device of the consumer, and wherein the presentation module is further configured to present the digital content to the mobile device of the consumer in response to receipt of the request.

20. A non-transitory machine-readable medium storing instructions that, when executed by one or more processors of a machine, cause the machine to perform operations comprising:
receiving a selection of digital content listings from a catalog of digital content listings, the catalog of digital content listings describing digital content available for download via a mobile device of a consumer, the selection being received from a mobile device of a merchant operating a brick-and-mortar store;
accessing digital content listings from the catalog of digital content listings based on the received selection of digital content listings;
determining that the consumer is located within a pre-defined distance from the brick-and-mortar store via the mobile device of the consumer; and
presenting the accessed digital content listings to the mobile device of the consumer.
